(19) United States
(12) Patent Application Publication
(10) Pub. No.: US 2012/0092907 A1
(43) Pub. Date: Apr. 19, 2012

(54) POWER SUPPLY AND SYSTEM

(75) Inventor: Hong-Kuo Hsu, New Taipei City (TW)

(73) Assignee: WISTRON CORP., NEW TAIPEI CITY (TW)

(21) Appl. No.: 13/037,197

(22) Filed: Feb. 28, 2011

(30) Foreign Application Priority Data
Oct. 15, 2010 (TW) TW99135178

(51) Int. Cl. H02H 7/125; H02M 1/44; H02M 1/12

(52) U.S. Cl. 363/44; 363/52

(57) ABSTRACT

The invention provides a power supply comprising a switch, a voltage detector and an SPS stage. The switch is coupled to an AC source. The voltage detector detects a voltage of the AC source. The SPS stage is coupled to the switch and outputs a DC voltage. When the voltage of the AC source is larger than a predetermined voltage, the switch is turned off to isolate the AC source from the SPS stage.

### CROSS REFERENCE TO RELATED APPLICATIONS

This Application claims priority of Taiwan Patent Application No. 099135178, filed on Oct. 15, 2010, the entirety of which is incorporated by reference herein.

### BACKGROUND OF THE INVENTION

1. Field of the Invention

The present invention relates to a power supply and more particularly to a power supply with a voltage protection device.

2. Description of the Related Art

When electronic devices, such as computers, or laptops, work by power from a transformer or an adapter connected to a commercial power which is not stable, this may easily damage the transformer or the adapter. In general, a typical switching power supply (SPS) is designed according to the magnitude of the alternative current (AC) voltage of commercial power, 110V˜240V, plus a voltage variation range, say, 10%. Thus, the voltage tolerance range of the typical switching power supply is between 90V and 264V.

When choosing the elements of a typical switching power supply during a design stage, such as an EMI circuit, bridge rectifier, bulk capacitor, MOSFET, or rectifier, common situations are considered, wherein, if specialized elements having large AC voltage tolerance are chosen, costs would dramatically increase without guaranteed effectiveness of the specialized elements.

### BRIEF SUMMARY OF THE INVENTION

One aspect of the invention is to provide a power supply with a voltage protection mechanism to avoid damage caused by an unstable local commercial power supply.

An embodiment of the invention provides a power supply which comprises a switch, a voltage detector and an SPS stage. The switch is coupled to an AC source. The voltage detector detects a voltage of the AC source. The switching power supply stage is coupled to the switch and outputs a DC voltage. When the voltage level of the AC source is larger than a predetermined voltage level, the switch is turned off to isolate the AC source from the switching power supply stage.

Another embodiment of the invention provides a power supply system. The power supply system is coupled to an AC voltage source and outputs a DC voltage. The power supply system comprises a switch, a voltage detector and a switching power supply stage. The switch is coupled to the AC voltage source. The voltage detector detects a voltage of the AC voltage source. The switching power supply stage is coupled to the switch and transforms a received AC voltage into the DC voltage, wherein when the voltage is larger than a predetermined voltage level, the switch is turned off to isolate the switching power supply stage from the AC voltage source.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic diagram of a power supply with a voltage protection device according to an embodiment of the invention.

FIG. 2 is a schematic diagram of a power supply with a voltage protection device according to another embodiment of the invention.

FIG. 3 is a circuit diagram of a power supply with a voltage protection device according to another embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

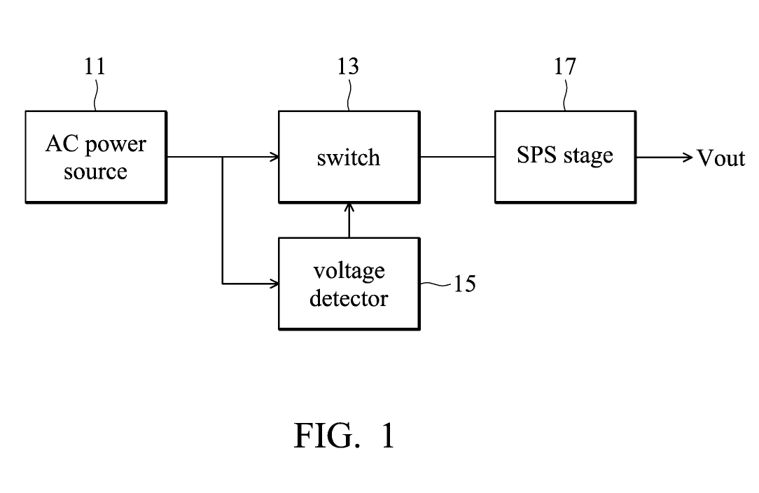

FIG. 1 is a schematic diagram of a power supply with a voltage protection device according to an embodiment of the invention. The AC power source 11 transmits the AC power to the switch power supply stage (SPS stage) 17 via the switch 13 and the SPS stage 17 transforms the input AC power to a direct current (DC) voltage Vout. The switch 13 is controlled by the voltage detector 15, and is initially set to be turned on. When the voltage detector 15 detects that the voltage of the AC power source 11 has exceeded a predetermined voltage level, the switch 13 is turned off to isolate the AC power source 11 from the SPS stage 17 to protect the SPS stage 17 from the high voltage from the AC power source 11. Similarly, this also protects the switch 13 from damage due to high voltage levels.

In this embodiment (the first embodiment), the voltage detector 15 continuously detects the voltage of the AC voltage source 11 and when the voltage of the AC power source 11 exceeds the predetermined voltage level, the switch 13 is turned off. In another embodiment (the second embodiment), the switch 13 continuously and actively monitors the detected voltage from the voltage detector 15. When the detected voltage level exceeds the predetermined voltage level, the switch 13 is turned off. In other words, the switch 13 is turned on or turned off according to the voltage of the AC power source 11. In the first embodiment, the switch 13 is initially set to be turned on and the switch is turned off only when the voltage detected by the voltage detector 15 is larger than the predetermined voltage level.

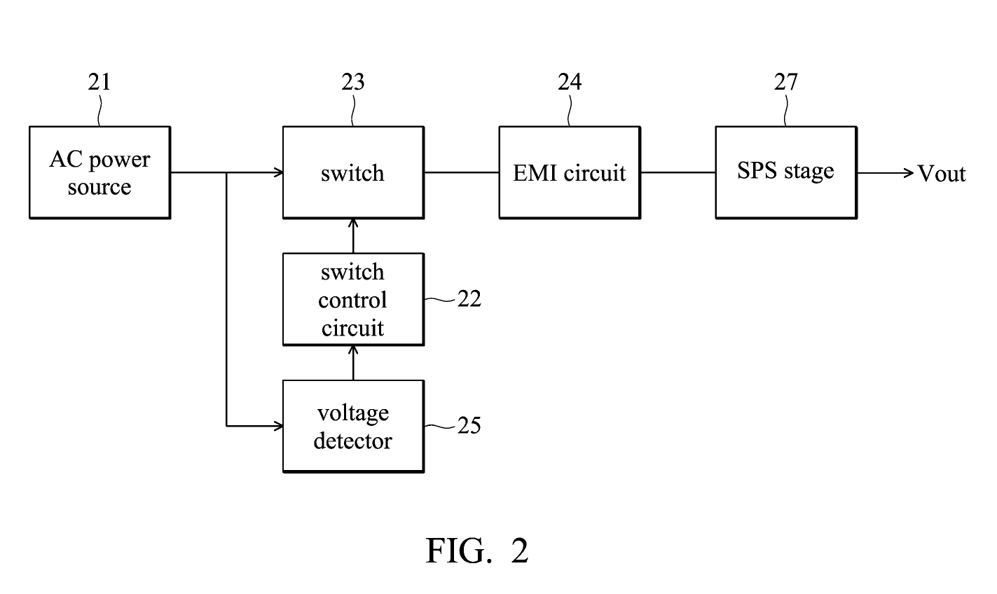

FIG. 2 is a schematic diagram of a power supply with a voltage protection device according to another embodiment of the invention. The AC voltage source 21 transmits the AC voltage to the SPS stage 27 via the switch 23 and the SPS stage 27 transform the AC voltage into a DC voltage. Before transmitting the AC voltage to the SPS stage 27, an electromagnetic disturbance circuit (EMI circuit) 24 first filters the noise of the AC voltage. The voltage detector 25 detects the voltage of the AC voltage source 21 and transmits the detected voltage to the switch control circuit 22. When the switch control circuit 22 determines that the voltage detected by the voltage detector 25 is larger than a predetermined voltage level, the switch control circuit 22 transmits a control signal to turn off the switch 23. In the embodiment of FIG. 2, the switch 23 is initially set to be turned on, and the switch is turned off only when the voltage detected by the voltage detector 25 is larger than the predetermined voltage level.

However, the switch 23 can be implemented in other ways. The switch 23 can be completely controlled by the switch control circuit 22. In other words, the switch control circuit 22 controls the switch 23 to be turned on or turned off. When the voltage detected by the voltage detector 25 is smaller than a predetermined voltage level, the switch control circuit 22 controls the switch 23 to be turned on. When the voltage detected by the voltage detector 25 is larger than a predetermined voltage level, the switch control circuit 22 controls the switch 23 to be turned off.

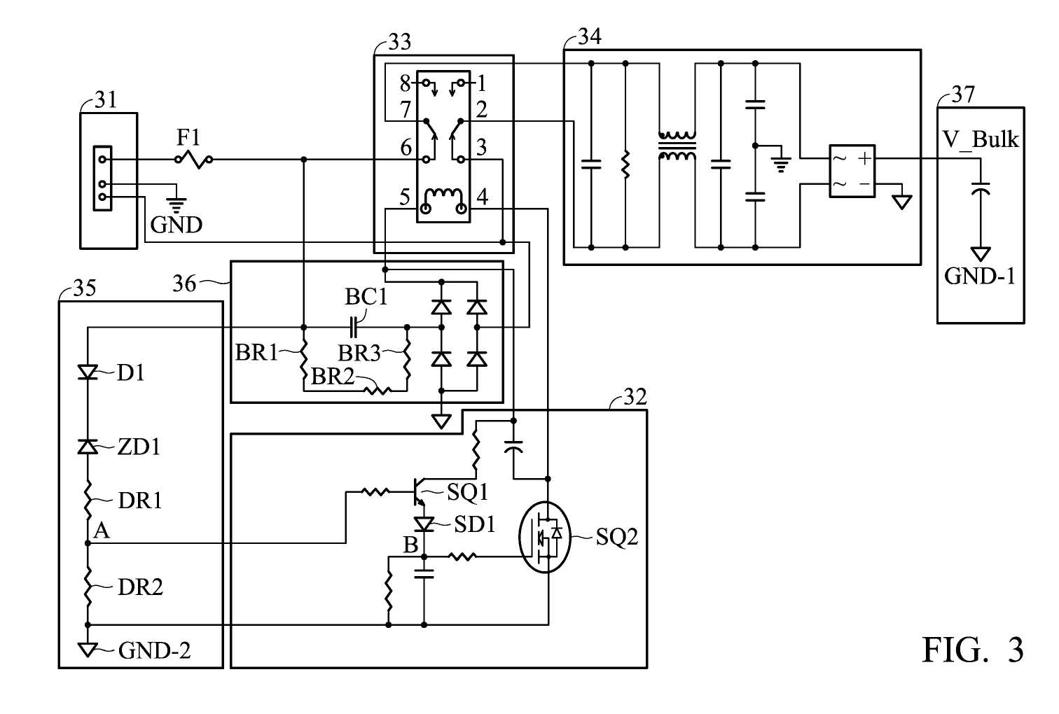

FIG. 3 is a circuit diagram of a power supply with a voltage protection device according to another embodiment of the invention. The circuit of the power supply of this embodiment can be applied to a power supply system or a power supply system inside an electronic device. In this embodiment, the switch 33 is illustrated with a relay, but the invention is not limited thereto. The switch 33 can also be implemented by a PMOS transistor, an NMOS transistor, a transmission gate or other similar devices. The switch 33 is initially set to be turned on, wherein the pin 2 is connected to the pin 3, the pin 6 is connected to the pin 7 and a coil is coupled between the pin 4 and the pin 5. When a current passes through the pin 4 and pin 5, the pin 2 is connected to the pin 1, and the pin 7 is connected to pin 8, and the switch 33 is therefore turned off. According to the described mechanism, power cannot be transmitted to the EMI circuit 34 and the SPS stage 27. In FIG. 3, a fuse F1 is further included. If the voltage of the AC voltage source 31 is too large, the fuse is melted to protect the circuit and elements of the power supply.

The voltage detector 35 detects the voltage of the AC voltage source 31 and sets a protection voltage level. The switch 33 allows the AC voltage to be transmitted to the EMI circuit 34 or the SPS stage 27 only when the transistor SQ2 of the switch 33 is not turned on. If the transistor SQ2 is turned on, the switch 33 isolates the AC voltage source 31 from the EMI circuit 34. Referring to the circuit of FIG. 3, the voltage V_{B} of node B controls the transistor SQ2 to be turned on or turned off. The transistor SQ2 is turned on only when the voltage V_{B} of node B is larger than the turn-on voltage Vgs of the transistor SQ2. The voltage V_{B} of node B varies according to the voltage V_{A} of the node A. Therefore, according to the circuit, the voltage of the AC voltage source 31 has to be larger than the break-down voltage of the Zener diode ZD1, if so, then the voltage can be transmitted to the node A and the voltage V_{A} is the divided voltage of resistor DR3 and DR4. According to the described mechanism, the equation for the peak voltage V_{AC-peak} of the AC voltage source when the transistor SQ2 is turned on can be derived.

$${V}_{AC \text{-} PEAK} = ( {V}_{B} + {V}_{BE} + {V}_{F \text{-} SD 1} ) x \frac{{R}_{DR 3} + {R}_{DR 4}}{{R}_{DR 3}} + {V}_{F \text{-} D 1} + {V}_{ZD 1}$$

V_{B}: The turn-on voltage of the transistor SQ2. 5V is illustrated in the embodiment.

V_{BE}: The forward bias from the base of the transistor SQ1 to the emitter of the transistor SQL The magnitude of the forward bias is about 0.7V.

V_{F-SD1}: The forward bias of diode SD1. The magnitude of the forward bias is about 0.7V.

V_{F-D1}: The forward bias of diode D1. The magnitude of the forward bias is about 0.7V.

V_{ZD1}: The break-down voltage of the Zener diode ZD1.

R_{DR3}: The resistance of resistor DR3.

R_{DR4}: The resistance of resistor DR4.

According to the described equation, a maximum tolerance voltage of the AC voltage in the voltage detector 35 can be set. Once the voltage of the AC voltage source exceeds the peak voltage V_{AC-peak}, the transistor SQ2 is turned on and the switch 33 opens to protect the EMI circuit 34 and SPS stage 37.

When the switch 33 is closed, the switch protection circuit 36 limits the current or voltage passing through the switch 33. The capacitor BC1 is for voltage-dropping or current-limiting purposes. The feature of the capacitor is to allow the AC current to pass therethrough and not allow the DC current to pass therethrough. When the capacitor connects to the circuit with AC power source, the electrical reactance derived can be expressed by the following equation:

XC=½πfC

XC represents the electrical reactance of the capacitor, f represents the frequency of the AC power source and the C is the capacitance of the voltage-dropping capacitor.

The current passing through the voltage-dropping circuit can be derived and expressed by the following equation:

I=U/XC

I represents the current passing through the capacitor, U represents the voltage of the voltage source, and XC represents the electrical reactance of the capacitor.

If the voltage of the AC power source is 220V, the frequency of the AC voltage is 50 Hz and the load voltage is lower than 220V, the relationship between the current and the capacitor can be described as follows:

I=69C,

wherein the unit of the capacitance C is uF and the unit of the current I is mA.

The resistor BR1˜BR3 are bleeder resistors to release remaining charges of the capacitor BC1 to protect a user and a device made therefrom, wherein the remaining charges are generated when the AC power is cut off and voltage of the sine wave of the AC power is at a peak value.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A power supply comprising:
a switch, coupled to an AC voltage source;
a voltage detector, detecting a voltage level of the AC voltage source; and
a switching power supply stage, coupled to the switch, to output a DC voltage,
wherein when the voltage level is larger than a predetermined voltage level, the switch is turned off to isolate the switching power supply stage from the AC voltage source.

2. The power supply as claimed in claim 1, further comprising:
a switch protection circuit, coupled to the switch, to limit a magnitude of a first voltage or a first current which travels through the switch when the switch is turned off.

3. The power supply as claimed in claim 1, further comprising:
a switch control circuit, coupled to the voltage detector and the switch, wherein when the voltage level is larger than the predetermined voltage level, the switch control circuit controls the switch to be turned off.

4. The power supply as claimed in claim 1, wherein the switch is initially set to be turned on, and the switch is turned off only when the voltage level is larger than the predetermined voltage level.

5. The power supply as claimed in claim 1, wherein the switch is a relay.

6. The power supply as claimed in claim 5, wherein the relay comprises a coil, and when a current travels through the coil, the relay is turned off.

7. The power supply as claimed in claim 5, wherein the switch is controlled by a switch control circuit, the switch control circuit comprises a transistor, and when the voltage level is larger than the predetermined voltage level, the transistor is turned on to let a current pass through a coil of the relay to turn the relay off.

8. The power supply as claimed in claim 1, further comprising:
an electromagnetic disturbance circuit, coupled between the switch and the switching power supply stage, to filter out an AC noise of the AC voltage source.

9. A power supply system, coupled to an AC voltage source to output a DC voltage, comprising:
a switch, coupled to the AC voltage source;
a voltage detector, detecting a voltage level of the AC voltage source; and
a switching power supply stage, coupled to the switch to transform a received AC voltage into the DC voltage, wherein when the voltage level is larger than a predetermined voltage level, the switch is turned off to isolate the switching power supply stage from the AC voltage source.

10. The power supply system as claimed in claim 9, further comprising:
a switch protection circuit, coupled to the switch, to limit a magnitude of a first voltage or a first current which travels through the switch when the switch is turned off.

11. The power supply system as claimed in claim 9, further comprising:
a switch control circuit, coupled to the voltage detector and the switch, wherein when the voltage level is larger than the predetermined voltage level, the switch control circuit controls the switch to be turned off.

12. The power supply system as claimed in claim 9, wherein the switch is initially set to be turned on, and the switch is turned off only when the voltage level is larger than the predetermined voltage level.

13. The power supply system as claimed in claim 9, wherein the switch is a relay.

14. The power supply system as claimed in claim 13, wherein the relay comprises a coil, and when a current travels through the coil, the relay is turned off.

15. The power supply system as claimed in claim 13, wherein the switch is controlled by a switch control circuit, the switch control circuit comprises a transistor, and when the voltage level is larger than the predetermined voltage level, the transistor is turned on to let a current pass through a coil of the relay to turn the relay off.

16. The power supply system as claimed in claim 9, further comprising:
an electromagnetic disturbance circuit, coupled between the switch and the switching power supply stage to filter out an AC noise of the AC voltage source.
